(19) United States
(12) Patent Application Publication
(10) Pub. No.: US 2008/0134762 A1
(43) Pub. Date: Jun. 12, 2008

(54) Airtight test method and apparatus thereof

(75) Inventors: Ching-Yuan Lin, Taipei City (TW); Meng-Chang Cheng, Taipei City (TW); Hsing-Hsiang Huang, Taipei City (TW); Jian-Jyun Li, Taipei City (TW)

Correspondence Address: Joe McKinney Muncy, PO Box 1364, Fairfax, VA, 22038-1364, US

(73) Assignee: National Taiwan University of Science & Technology

(21) Appl. No.: 11/806,784

(22) Filed: Jun. 4, 2007

(30) Foreign Application Priority Data
Dec. 8, 2006 (TW) 95145935

(51) Int. Cl. G01M 3/00

(52) U.S. Cl. 73/46

(57) ABSTRACT

An airtight test method is provided. The method includes the following steps. First, an opening structure is provided, wherein the opening structure is formed on a building structure. A seal structure is subsequently pressed against the corresponding opening structure, wherein the opening structure and the seal structure compose a chamber. Next, a pressure supply unit is connected to the chamber. A pressure difference is subsequently generated in the chamber by the pressure supply unit. Finally, a measured flow rate between the pressure supply unit and the chamber is detected to measure the airtightness of the opening structure.

### BACKGROUND OF THE INVENTION

1. Field of the Invention

The invention relates to an airtight test method, and more particularly to an airtight test method for testing the airtightness of an opening structure.

2. Description of the Related Art

In conventional airtight test method for testing the airtightness of an opening structure, such as that regulated by ISO 5925-1, DIN 18095-2, UL 1784 and BS 476-31, a fixed test chamber is provided. The opening structure, for example, a door, is disposed in the test chamber. Then, a pressure difference is exerted in the test chamber, and the leakage, known as flow rate, of the opening structure is detected for measuring the airtightness thereof.

Test chambers, however, increase the cost of the conventional airtight test. Additionally, the tested opening structure is precisely disposed in a test chamber rather than disposed on a building, thus, test results of conventional airtight tests do not necessarily accurately determine the airtightness of a tested structure.

### BRIEF SUMMARY OF THE INVENTION

A detailed description is given in the following embodiments with reference to the accompanying drawings.

The invention discloses airtight test methods. In an exemplary embodiment of an airtight test method, an opening structure formed on a building structure is first provided. A seal structure is then pressed against the corresponding opening structure. The opening structure and the seal structure compose a chamber. Next, a pressure supply unit is connected to the chamber. A pressure difference is then generated in the chamber by the pressure supply unit. Finally, a flow rate between the pressure supply unit and the chamber is detected to measure the airtightness of the opening structure.

The embodiment utilizes a simplified airtight testing apparatus, thus cost is reduced. Additionally, the airtight test apparatus is disposed on the building that the opening structure belongs to. Therefore, test result of the airtight test of the embodiment sufficiently reflects airtight of practical situation.

### BRIEF DESCRIPTION OF THE DRAWINGS

The invention can be more fully understood by reading the subsequent detailed description and examples with references made to the accompanying drawings, wherein:

FIG. 1 shows an airtight test apparatus of an embodiment of the invention;

FIG. 2 shows the airtight test apparatus installed on building structure;

FIG. 3 shows an airtight test method of the invention;

FIG. 4 shows a second embodiment of the invention;

FIG. 5 shows a third embodiment of the invention; and

FIG. 6 shows detailed structure of a framework of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention incorporates by reference “The Experimentation of Detecting Shelter Performance across Building Opening Assemblies in Ambient Temperature”, June 2006, National Taiwan University of Science and Technology, Meng-Chang Cheng and

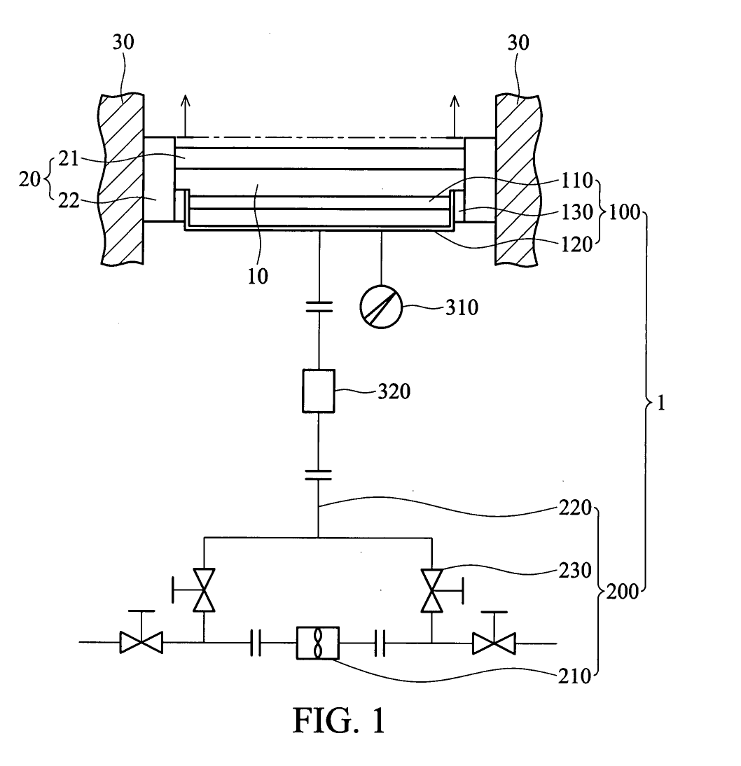

FIG. 1 shows an airtight test apparatus 1 of a first embodiment of the invention; comprising a seal structure 100, a pressure supply unit 200, a pressure detector 310 and a flow rate detector 320. The seal structure 100 comprises a framework 110, a soft material 120 and a seal material 130. The soft material 120 is disposed on the framework 110. The seal structure 100 is disposed on an opening structure (door structure) 20. The opening structure 20 comprises a door 21 and a frame 22. The door 21 pivots on the frame 22. The seal structure 100 abuts the frame 22. The seal material 130 and a partial of the soft material 120 are sandwiched between the framework 110 and the frame 22 to fix the soft material 120 and improve airtightness of the seal structure 100. The soft material 120 is plastic sheeting, and the seal material 130 is sponge. The opening structure 20 is disposed on a building structure 30, for example, a wall. The door 21, the frame 22 and the seal structure 100 compose a chamber 10. The pressure supply unit 200 is connected to the chamber 10 to generate a pressure difference in the chamber.

The pressure supply unit 200 comprises a fan 210, a flow path 220 and a plurality of valves 230. The flow path 220 connects the fan 210 and the chamber 10. The fan 210 is an axial fan. The fan 210 exerts a pressure difference in the chamber 10 via the flow path 220. The pressure difference can be a positive or negative pressure about 5 to 30 Pa, for example, 20 Pa. When a building is on fire, the pressure difference between rooms separated by a door is about 20 Pa. In the embodiment of FIG. 1, the pressure difference is a positive pressure. The valves 230 control the pressure supplied by the pressure supply unit 200.

The flow rate detector 320 is disposed on the flow path 200 to detect flow rate therein. A filter can be disposed in the flow path 200 to prevent the flow rate detector 320 from destruction.

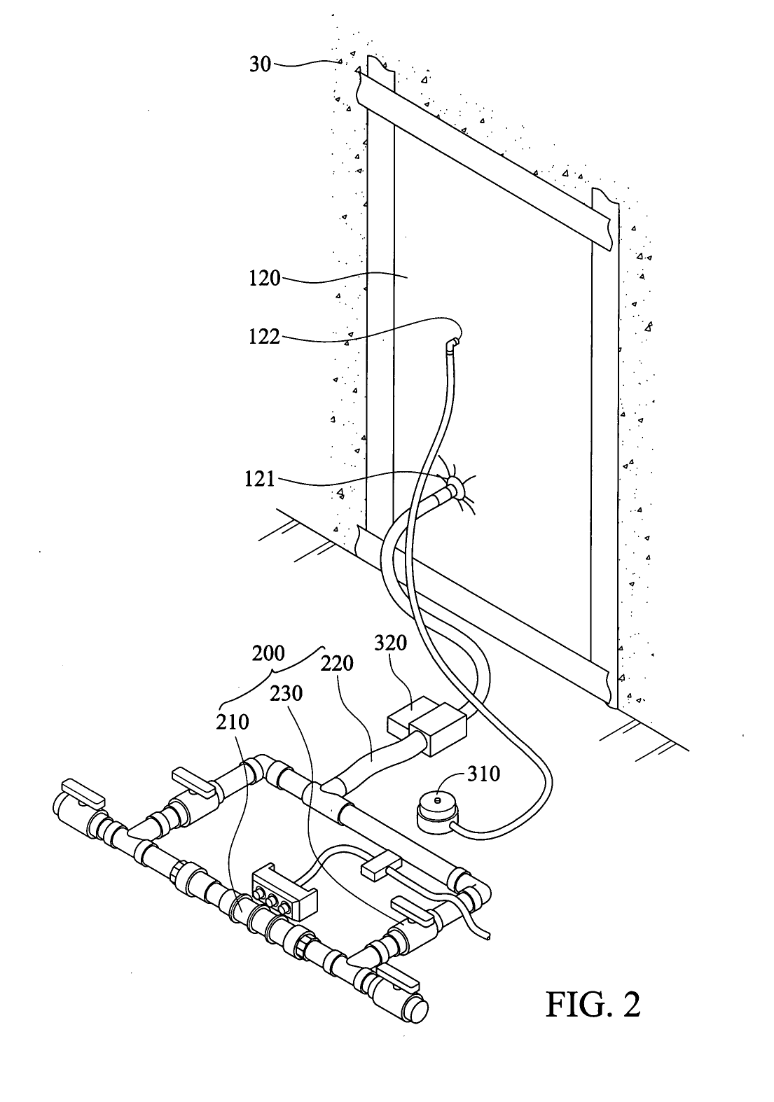

FIG. 2 shows the airtight test apparatus 1 combining with the building structure 30. The soft material 120 comprises a first opening 121 and a second opening 122. The flow path 220 is connected to the first opening 121. The pressure detector 310 is connected to the second opening 122.

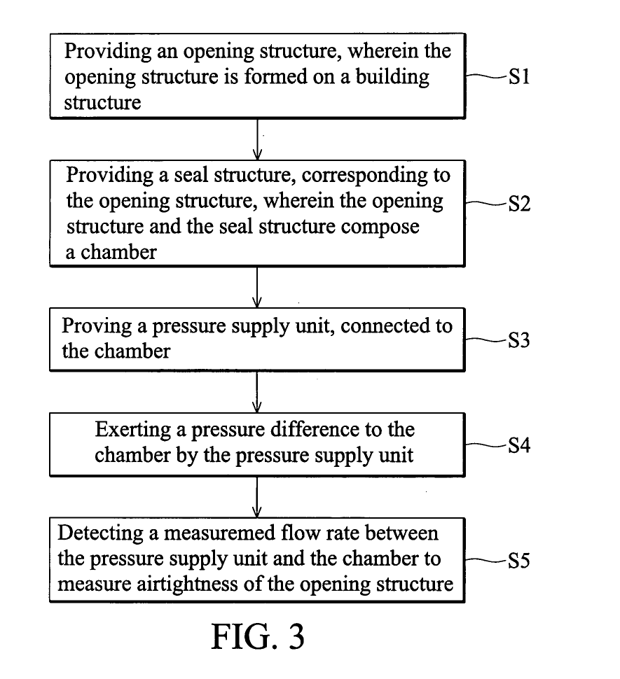

FIG. 3 shows an airtight test method of the invention. First, an opening structure is provides, wherein the opening structure is formed on a building structure (S1). Then, a seal structure is exerted corresponding to the opening structure, wherein the opening structure and the seal structure comprise a chamber (S2). Next, a pressure supply unit is provided connected to the chamber (S3). Then, a pressure difference is provided to the chamber by the pressure supply unit (S4). Finally, a measured flow rate between the pressure supply unit and the chamber is detected to measure the airtightness of the opening structure (S5).

The flow rate detector 320, as shown in FIG. 1, detects the flow rate. A practical leakage is achieved by subtracting a basic leakage of the seal structure from the measured flow rate. The basic leakage of the seal structure is gathered by experiment. The practical leakage represents a total leakage of the opening structure, and airtightness of the opening structure is thus achieved.

The embodiment utilizes a simplified airtight testing apparatus, thus cost is reduced. Additionally, the airtight test apparatus is disposed on the building that the opening structure belongs to. Therefore, test result of the airtight test of the embodiment sufficiently reflects airtight of practical situation.

The embodiment can be utilized in airtight test, particularly in smoke separation test.

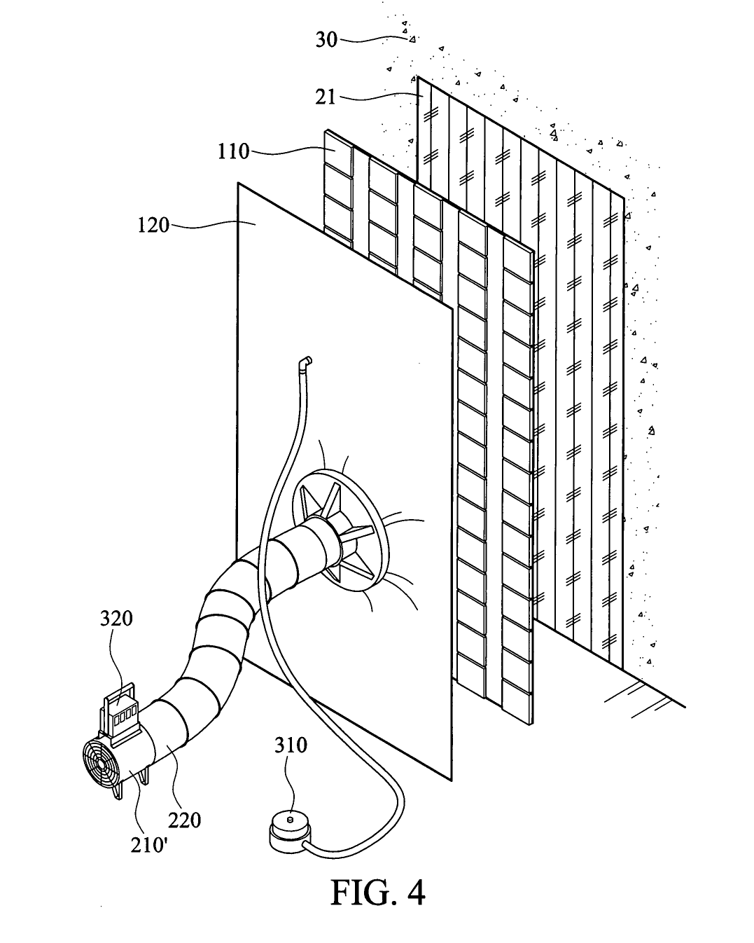

FIG. 4 shows a second embodiment of the invention, wherein the fan 210′ is a two-way blower, and the flow rate detector 320 is disposed thereon.

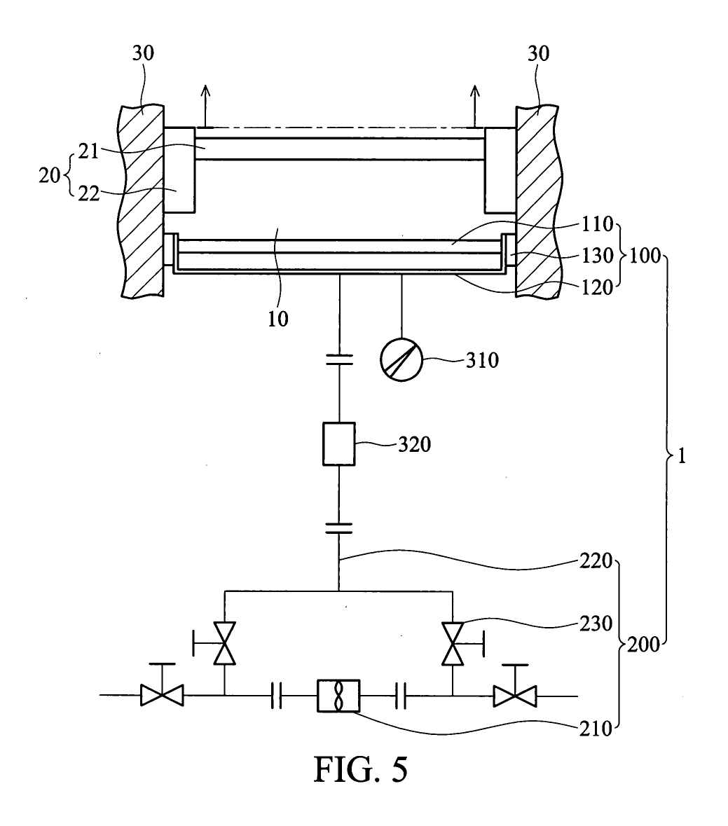

FIG. 5 shows a third embodiment of the invention, wherein the seal structure 100 abuts the building structure 30 corresponding to the door 21. The opening structure 20, the building structure 30 and the seal structure 100 compose the chamber 10.

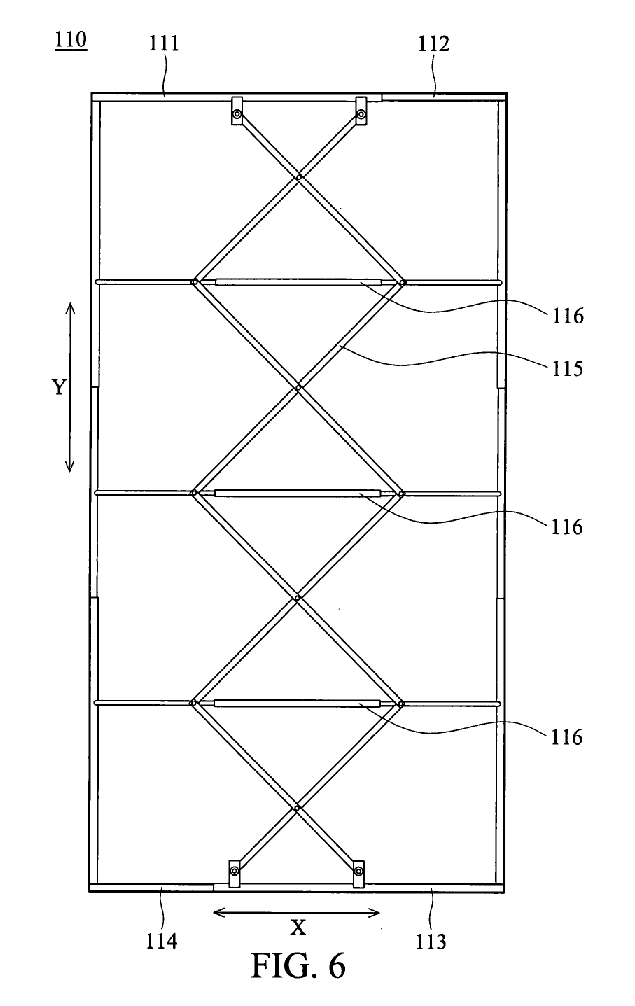

FIG. 6 shows the detailed structure of the framework 110, comprising a first section 111, a second section 112, a third section 113, a fourth section 114, a bar linkage mechanism 115, and reinforcing bars 116. The first section 111 and the second section 112 move in a first direction Y corresponding to the third section 113 and the fourth section 114 to modify a length of the framework 110. The first section 111 and the fourth section 114 move in a second direction X corresponding to the second section 112 and the third section 113 to modify a width of the framework 110. The bar linkage mechanism 115 is disposed on the first section 111, the second section 112, the third section 113, and the fourth section 114. The first section 111 and the second section 112 move in the first direction Y corresponding to the third section 113 and the fourth section 114 via the bar linkage mechanism 115. The first section 111 and the second section 112 slide relatively in the second direction X, and the third section 113 and the fourth section 114 slide relatively in the second direction X. The reinforcing bars 116 are disposed between the first section 111, the second section 112, the third section 113, and the fourth section 114 to improve strength of the framework 110.

While the invention has been described by way of example and in terms of preferred embodiment of the invention, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An airtight test method, comprising:
providing an opening structure, wherein the opening structure is formed on a building structure;
providing a seal structure, corresponding to the opening structure, wherein the opening structure and the seal structure compose a chamber;
providing a pressure supply unit, connected to the chamber;
generating a pressure difference in the chamber by the pressure supply unit;
detecting a measured flow rate between the pressure supply unit and the chamber to measure airtightness of the opening structure.

2. The airtight test method as claimed in claim 1, wherein the pressure supply unit generates a positive pressure in the chamber.

3. The airtight test method as claimed in claim 1, wherein the pressure supply unit generates a negative pressure in the chamber.

4. The airtight test method as claimed in claim 1, further comprising subtracting a basic leakage of the seal structure from the measured flow rate to achieve a practical leakage.

5. The airtight test method as claimed in claim 1, wherein the pressure difference is about 5 to 30 Pa.

6. The airtight test method as claimed in claim 1, wherein the pressure difference is about 20 Pa.

7. The airtight test method as claimed in claim 1, wherein the opening structure comprises a door and a frame, the door pivots on the frame, the seal structure abuts the frame, and the seal structure, the door and the frame compose the chamber.

8. An airtight test method, comprising:
providing an opening structure, wherein the opening structure is formed on a building structure;
providing a seal structure, corresponding to the opening structure, wherein the opening structure, the building structure and the seal structure compose a chamber;
exerting a pressure supply unit, connected to the chamber;
providing a pressure difference to the chamber by the pressure supply unit;
detecting a measured flow rate between the pressure supply unit and the chamber to measure airtightness of the opening structure.

9. The airtight test method as claimed in claim 8, wherein the opening structure comprises a door and a frame, the door pivots on the frame, the seal structure abuts the building structure, and the seal structure, the building structure, the door and the frame compose the chamber.

10. An airtight test apparatus, comprising:
a seal structure, comprising:
a framework;
a soft material, disposed on the framework, comprising a first opening and a second opening; and
a seal material, disposed on edges of the framework;
a pressure supply unit, comprising a fan and a flow path, the flow path connecting the fan and the first opening;
a flow rate detector, disposed in the flow path to detect a measured flow rate therefrom; and
a pressure detector, connected to the second opening.

11. The airtight test apparatus as claimed in claim 10, wherein the fan is an axial fan.

12. The airtight test apparatus as claimed in claim 10, wherein the pressure supply unit further comprises a valve, disposed in the flow path for controlling a pressure therein.

13. The airtight test apparatus as claimed in claim 10, wherein the soft material is a plastic sheet.

14. The airtight test apparatus as claimed in claim 10, wherein the seal material is a sponge.

15. The airtight test apparatus as claimed in claim 10, wherein the framework comprises a first section, a second section, a third section and a fourth section, the first and second sections move in a first direction corresponding to the third and fourth sections to modify a length of the framework, and the first and fourth sections move in a second direction corresponding to the second and third sections to modify a width of the framework.

16. The airtight test apparatus as claimed in claim 15, wherein the framework further comprises a bar linkage mechanism, disposed on the first, second, third and fourth sections, and the first and second sections move in the first direction corresponding to the third and fourth sections via the bar linkage mechanism.

17. The airtight test apparatus as claimed in claim 15, wherein the first and the second sections slide relatively in the second direction, and the third and the fourth sections slide relatively in the second direction.
